(19) United States
(12) Patent Application Publication
(10) Pub. No.: US 2007/0283108 A1
(43) Pub. Date: Dec. 6, 2007

(54) Memory Management System

(76) Inventors: Robert G. Isherwood, Buckinghamshire (GB); Paul Rowland, Hertfordshire (GB)

Correspondence Address: FLYNN THIEL BOUTELL & TANIS, P.C., 2026 RAMBLING ROAD, KALAMAZOO, MI, 49008-1631, US

(21) Appl. No.: 11/632,564

(22) PCT Filed: Jul. 15, 2005
(86) PCT No.: PCT/GB05/02799

§ 371 Date: Jul. 20, 2007

(30) Foreign Application Priority Data
Jul. 15, 2004 (GB) 0415850.7

(51) Int. Cl. G06F 12/10

(52) U.S. Cl. 711/154

(57) ABSTRACT

A system and method for managing accesses to a memory are provided. A memory management unit (MMU) and a translation lookaside buffer (TLB) are used. The TLB stores addresses of pages which have been recently accessed. The MMU includes a virtual map of an MMU table which stores physical addresses of memory pages linked to logical addresses. A virtual map is stored in a linear address space and the MMU can update the addresses stored in the TLB in response to memory accesses made in the MMU table. The MMU table comprises at least first and second level table entries. The first level table entries store data for map logical addresses to the second level table entries. The second level table entries store data for map logical addresses to physical addresses in memory.

### FIELD OF THE INVENTION

This invention relates to a memory management system of the type frequently used within microprocessors.

### BACKGROUND TO THE INVENTION

A memory management system includes a memory management unit (MMU). This is a usually hardware device contained within a microprocessor that handles memory transactions. It is configured to perform functions such as translating virtual addresses into physical addresses, memory protection, and control of caches.

Most MMUs consider memory as a collection of regularly sized pages of e.g. four kilobytes each. An MMU table is contained in physical memory which defines the mapping of virtual memory addresses to physical pages. This table also includes flags used for memory protection and cache control. Because of the large virtual address spaces involved, this table is normally fairly sparsely populated. Because of this it is usually contained in some kind of hierarchical memory structure or in a collection of linked lists. Accessing the table in physical memory is inherently slow and so the MMU usually contains a cache of recent successfully addressed pages. This cache is known as a translation lookaside buffer (TLB).

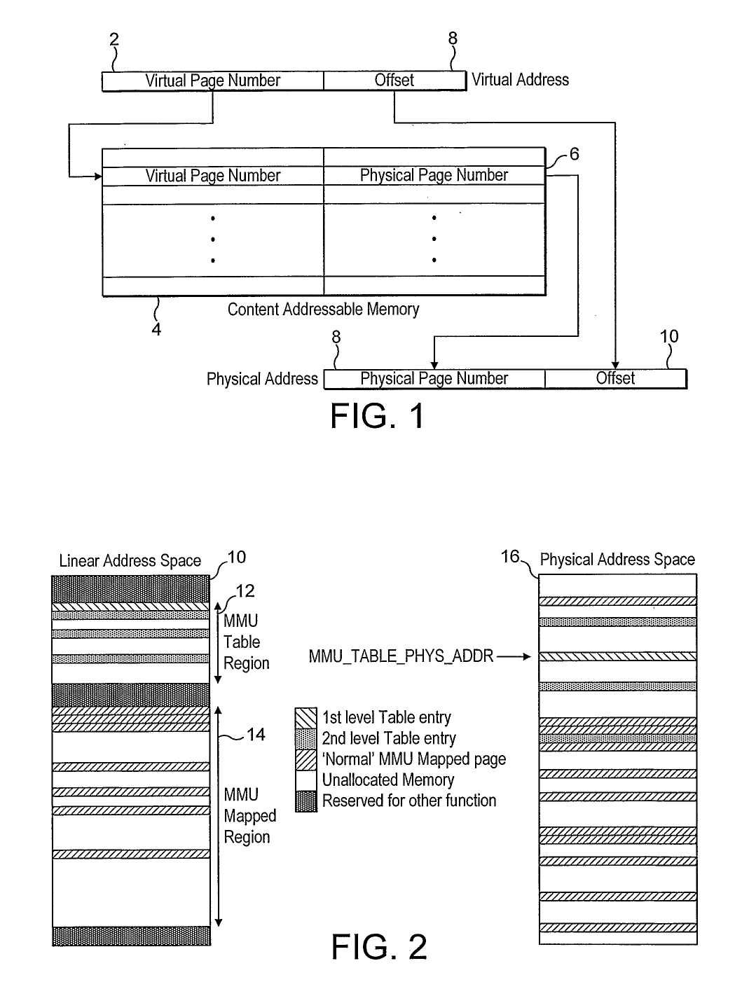

A block diagram showing the structure and operation of a TLB is shown in FIG. 1. The Input to the TLB is a virtual address which may be split into two parts—a virtual page number and an Offset. The top bits of the virtual address represent a virtual page number 2 which forms an input to a content addressable memory 4 (CAM). This content addressable memory takes the virtual page 6 number, and attempts to match it with a list of virtual page numbers. If a match is found, the corresponding physical page number then forms an output which produces the physical address 8 which can be used to access the memory. The bottom bits of the address (the offset 8) are not modified by the translation and they therefore form the bottom bits of the physical address at 10. If no match is found in the CAM, the page table in physical memory must be accessed via an appropriate table walking algorithm to perform the translation. A fetched page table entry would then be cached in the TLB for future use.

Updates to an MMU table are generally made by direct access to physical memory. This poses a number of challenges to programmers. Firstly, the software must ensure that any changes which are made to the table in physical memory are also reflected in the cached version held in the TLB. Typically this would involve flushing that entry from the TLB. However, the problem of maintaining coherency is especially difficult in real time multi-threaded systems where, for example, one thread could be using a page table entry while another is attempting to update it.

### SUMMARY OF THE INVENTION

Preferred embodiments of the invention provide a memory management unit in which a virtual map of an MMU table is implemented. Reads and writes to a fixed region in the linear address space of the table are used to form updates to the MMU table. These transactions are handled by the MMU so it is able to ensure that its TLB is kept up to date as well as performing updates to the table in physical memory. Furthermore, the MMU automatically performs the mapping of physical table addresses for the table entries. There is no need for software to perform this.

In accordance with a first aspect of the invention there is provided a system for managing accesses to a memory comprising a memory management unit (MMU) and a translation lookaside buffer (TLB) in which pages recently accessed are cached, the MMU including a virtual map of an MMU table storing physical addresses of memory pages linked to logical addresses, the virtual map being stored in a linear address space, and wherein the MMU can update the addresses stored in the TLB in response to memory accesses made in the MMU table.

In accordance with a second aspect of the invention there is provided a system for managing accesses to memory comprising an MMU, the MMU including a virtual map of an MMU table for mapping logical addresses to physical addresses in memory, the MMU table being stored in a linear address space, the MMU table comprising at least first and second level table entries, the first level table entries storing data to map logical addresses to the second level table entries, the second level table entries storing data to map logical addresses to physical addresses in memory, and operable in response to a memory access request to a) retrieve a first level table entry from the MMU table, b) retrieve a second level table entry using the first level table entry, and c) access physical memory locations using the second level table entry.

### DETAILED DESCRIPTION OF PREFERRED EMBODIMENTS

Preferred embodiments of the invention will now be described in detail by way of example with reference to the accompanying drawings in which:

FIG. 1 is a block diagram of a translation lookaside buffer (TLB) as described above;

FIG. 2 shows schematically an MMU memory map;

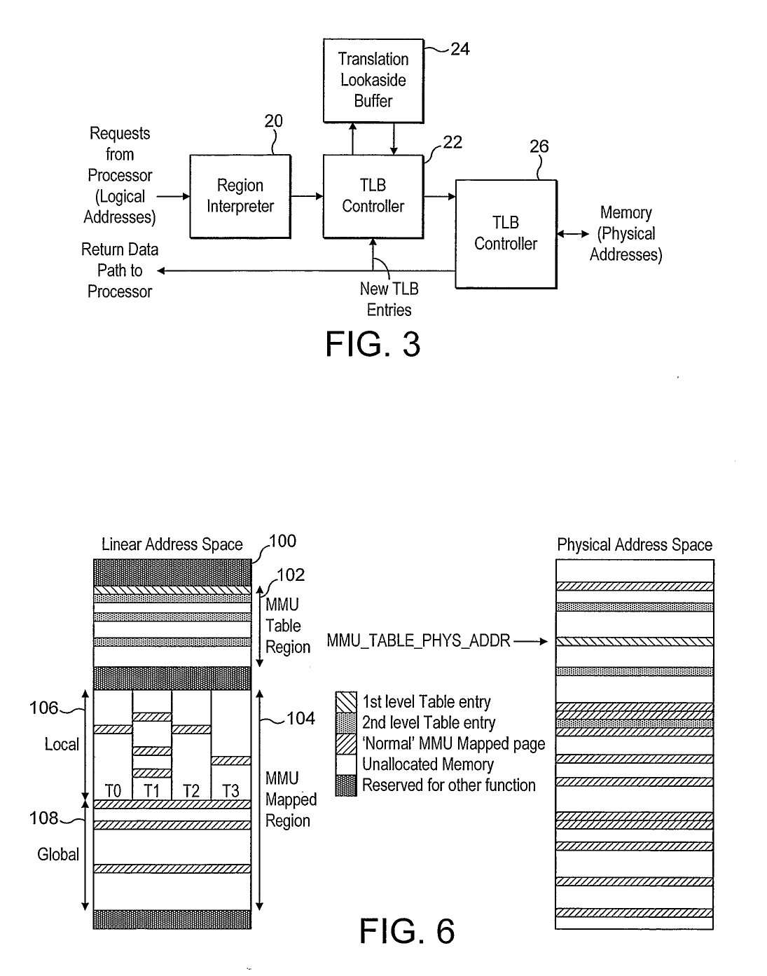

FIG. 3 shows a block diagram of the MMU;

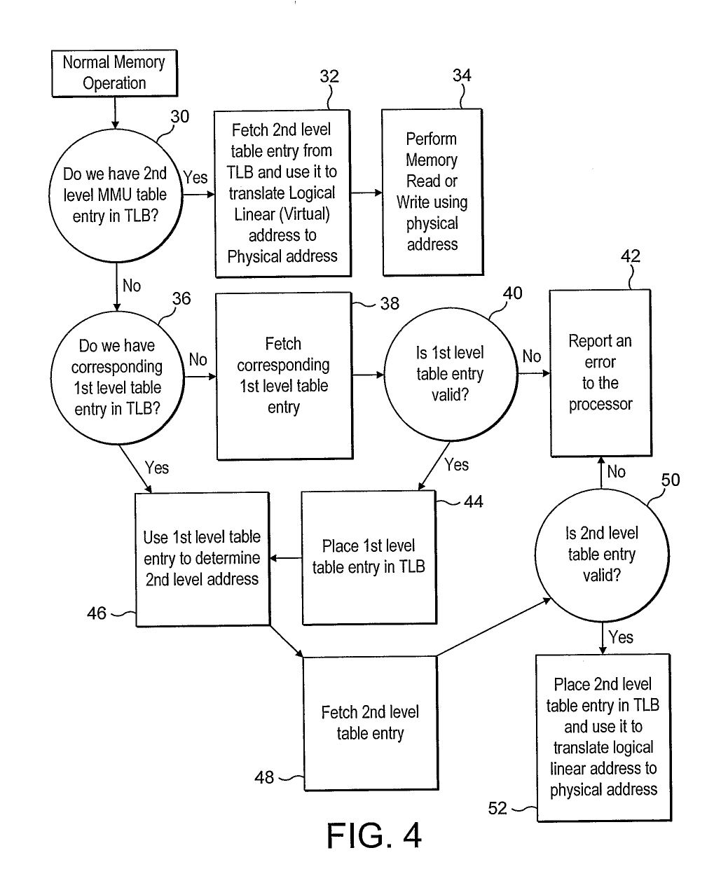

FIG. 4 shows a schematic diagram of TLB controller functionality for normal memory transactions;

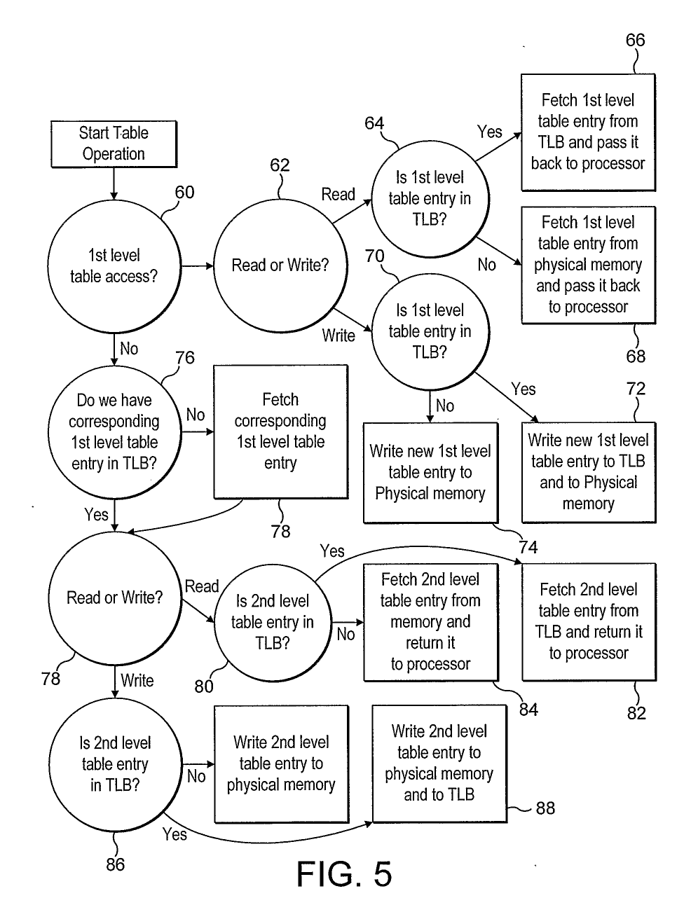

FIG. 5 shows a schematic diagram of TLB controller functionality for MMU table operations;

FIG. 6 shows a memory map for a multi-threaded MMU processor; and

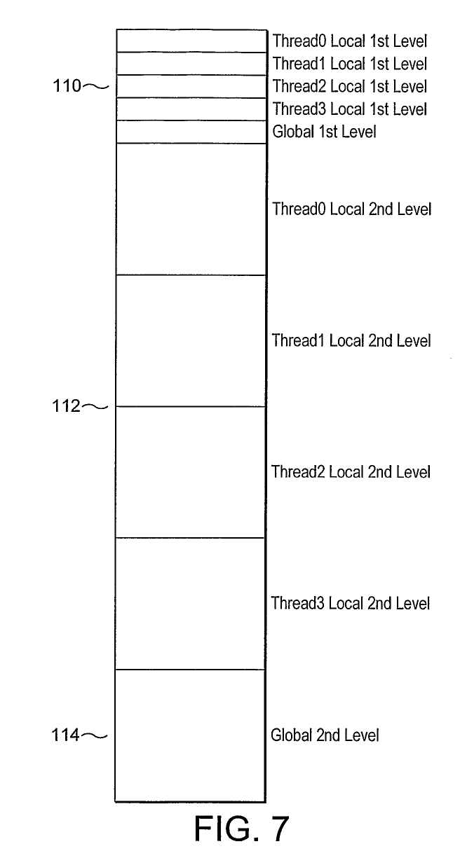

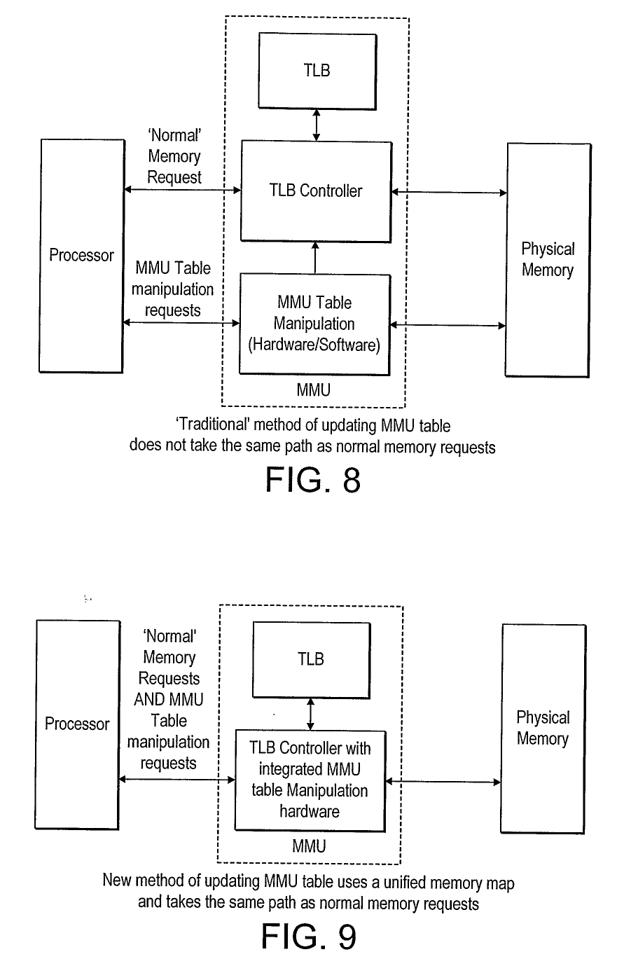

FIG. 7 shows an example of a multi-threaded MMU table region layout embodying the invention.

The principal difference between the embodiment and the prior art is that physical address space 16 is organised via an MMU table region 12. This and the MMU mapped region 14 are located in physical address space 16 but are organised as a virtual linear address space 10. The MMU table region comprises first and second level table entries which determine the organisation of physical memory. The first and second level table entries have fixed locations in the linear address space. The first level entries provide a mapping to physical addresses for the second level entries. The second level entries provide mapping to physical addresses for the addresses in the MMU mapped region 14.

The position of the root of the MMU table region in physical memory is stored in a register which must be programmed before the MMU is used. The value of this register is defined to be MMU_TABLE_PHYS_ADDR. Once this root address is determined the MMU table can be set up to define the addresses in the MMU mapped region which are then used to access physical addresses in the memory being controlled.

All updates to the MMU table are made via the MMU table region in linear address space. This ensures that MMU table data currently cached in the MMU is maintained during normal system operation. In this particular example, the MMU table is implemented in a hierarchical form with the first and second level MMU page table entries. The pages are 4K bytes and a 32 bit address is used. However, the table can have more levels of hierarchy or could be a single layer and page sizes and address lengths can vary without altering the effect.

In physical address space the first level table can be found at the root address of the MMU table stored in the register. This first level table entry gives access to the various second level table entries and then to the MMU mapped pages which may be scattered randomly throughout the memory.

In order to assign a 4K byte of physical memory the user must first initialise the MMU table. This is done by entering the physical base table address in the MMU_TABLE_PHYS_ADDR register. This first level table entry of the MMU table is then filled with the physical base address of the 4K byte page to be assigned. This activates one thousand and twenty-four second level table entries, each of which is mapped to a 4K byte page. Therefore, each first table entry address is associated with up to 4M bytes of memory that is to be mapped.

Only the first level table MMU table entries corresponding to valid regions of the MMU table itself need to be supported via a single contiguous region of physical RAM. This requires only a few K bytes of physical RAM to be preallocated to support the MMU root table. Additional 4K pages are added for storage of second level entries as required to build up a full linear address mapping table of the system.

A block diagram of a system in which the invention is embodied is shown in FIG. 3. This comprises a region interpreter 20 which receives memory access requests from a processor. These are supplied to a TLB controller 22 which accesses a translation lookaside buffer 24 before sending the physical address to the memory interface 26. If there is no corresponding address in the TLB one is generated via the TLB controller 22 and memory interface 26. The entry is returned to the processor on a separate path, and is also supplied via the same path to the TLB controller 22 to update the TLB 24.

The region interpreter 20 determines the type of transaction the processor is making. This could be a normal memory read or write, an MMU table first or second level read or write, or a “reserved” transaction. This information is then supplied to the TLB controller which performs the functions shown in FIGS. 4 and 5 and discussed below with the assistance of the TLB 24.

FIG. 4 illustrates the functionality of the TLB controller for normal memory transactions. It shows what happens when the TLB is able to provide direct access to a cached page and the steps taken to walk through the MMU table to fetch a new TLB entry if there is no cached page.

In normal memory operation when a memory access is required a determination is made at 30 as to whether or not the second level MMU table entry is present in the TLB. If there is, then the second level table entry is fetched from the TLB and used to translate logical linear (virtual address to physical address) at 32 before performing a memory read or write using this physical address at 34. If there is no second level table entry then a determination is made as to whether or not there is a corresponding first level table entry at 36. In this system, there is a simple mapping between first and second level table entry logical addresses so determining whether there is a corresponding first level entry is relatively simple. If there is not a corresponding first level table entry in the TLB then this is fetched from the MMU table at 38 in physical memory before a determination is made at 40 as to whether or not it is valid. If it is not valid an error report is sent to the processor at 42. If it is valid it is placed in the TLB at 44 and then used at 46 to determine a second level address. A second level table address is then fetched at 48 before a determination as to whether or not it is valid is made at 50. If it is valid then a second level table entry is placed in the TLB and used to translate a logical linear address to a physical address at 52. If at 36 the corresponding first level table entry is present in the TLB then the process steps straight to step 46 where the first level table entry is used to determine the second level address.

FIG. 5 illustrates how an MMU table operation is performed. First level table manipulations can be simple in that data can be simply fetched or written to and from the TLB table and external memory as appropriate. Second level manipulations are slightly more complex in that they require the corresponding first level entry in order to determine where the physical memory of the second level entry is stored.

At 60, a determination is made as to whether or not a first level table access is to be made. If it is then a determination is made at 62 as to whether or not it is a read or write. If it is a read then at 64 a determination is made as to whether or not a first level table entry is in the TLB. If it is then it is fetched from the TLB and passed back to the processor at 66. If it is not then it is fetched from physical memory and passed back to the processor at 68. If the operation is a write then a determination is made at 70 as to whether or not the first level table entry is in the TLB. If it is then at 72 a new first level table entry is written to both the TLB and physical memory. If it is not then a new first level table entry is written only to physical memory at 74.

If at 60 the determination is that it is not a first level table access which is required then at 76 a determination is made as to whether or not a corresponding first level table entry is present in the TLB. If it is not then this is fetched from physical memory at 78. If it is then a determination is made at 78 as to whether or not it is a read or a write. If it is a read then a determination is made at 80 as to whether or not a second level entry is in the TLB. If it is then it is fetched from the TLB and returned to the processor at 82. If it is not then it is fetched from memory and returned to the processor at 84.

If the operation is a write then the same determination is made a determination is made as to whether or not a second level table entry is in the TLB at 86. If it is then the second level table entry is written to both physical memory and to the TLB at 88. If it is not then the second level table entry is written only to physical memory at 90. The above description assumes the use of a two-dimensional hierarchical data structure for the MMU page table and physical memory. However, any alternative data structure could be used with appropriate modifications to the hardware for accessing the table. For example the number of levels of hierarchy could be increased to any number to allow mapping of a larger address space, or for simple systems the hierarchy could be reduced to just one level.

The invention may also be embodied in, and is particularly appropriate to a multi-threaded system in which multiple processing threads use the same processor. In such a situation, an additional signal entering the MMU indicates the thread being used at that time. This additional data signal can be used as an additional parameter in determining how logical addresses are converted to physical addresses. Different mappings can be applied to each thread. For convenience we define the mapping applied for each thread as local memory accesses which access dedicated portions of a common global memory for accessing memory and also a common global area that performs the same mapping irrespective of the thread number.

Such an arrangement is shown in FIG. 6. The linear address space (virtual addresses) are shown at 100. This comprises an MMU table region 102 and the MMU mapped region 104. The MMU mapped region (data storage region) is divided into two portions, the local memory 106 and the global memory addresses 108. As can be seen, the local memory addresses are labelled T0, T1, T2 and T3 for use by four threads, T0 to T3. Addresses in the local MMU mapped region are mapped by the MMU using data that is specific to a thread. Data that is fetched and cached in this region will not be available to the other threads. Addresses in the global MMU mapped region are mapped by the MMU using data global to all threads. Locations in this region may be cached in a common part of the cache and used by all threads.

Preferably the MMU table region is structured in a similar manner to that discussed above with first and second level table entries having common global entries and local entries for particular threads. Alternatively, in some systems it may be convenient if a thread can set up an access to the table of another thread. This would enable each thread's local MMU tables to be structured one after another as illustrated in FIG. 7. This shows the first level thread entries at 110 followed successively by the threads second level table entries at 112 and a global second level table entry at 114, one difference between embodiments in the present invention and prior art systems is in the provision of a unified logical address space in which a region of memory is set aside known as the MMU table region. This region is used specifically for updating the MMU table entries. The MMU, the TLB controller and the associated logical memory systems have complete access to MMU table entries since they are passed through the same pipelines as normal logical memory requests. Because of this the TLB controller and any other hardware is able to respond to these transactions coherently.

It will be appreciated, that the same pipelines are used for table manipulation as are used for normal memory access requests and a TLB controller deals with these directly. Because of this, it is relatively easy for the TLB controller to automatically update the MMU table as appropriate without suspending the flow of normal memory access requests. In prior art systems, this is not achievable without temporarily suspending the flow of normal memory access requests. This has an even more pronounced effect in the multi-threaded systems where in the prior art it will be necessary to suspend all the other threads or to provide complex thread intercommunication and the MMU table as being updated. This is not necessary with the embodiment described in the present invention.

1-26. (canceled)

27. A system for managing accesses to a memory comprising a memory management unit (MMU) and a translation lookaside buffer (TLB) in which pages recently accessed are cached, the MMU including a virtual map of an MMU table storing physical addresses of memory pages linked to logical addresses, the virtual map being stored in a linear address space, and wherein the MMU can update the addresses stored in the TLB in response to memory accesses made in the MMU table wherein the MMU table comprises at least first and second level table entries, the first and second level table entries having fixed locations in the linear address space, the first level table entries include data which maps them to physical addresses of the second level table entries, and the second level entries provide mapping to physical addresses for data storage and wherein the mapping of first level entries to the second level table entries is performed with mapping a device and the mapping of the second level table entries to physical addresses for data storage is performed with the same mapping device.

28. A system according to claim 27 in which the first level table entries are stored in a continuous portion of memory.

29. A system according to claim 27 included in a microprocessor system.

30. A method for managing accesses to a memory comprising the steps of storing a virtual map of a memory management unit (MMU table) comprising physical addresses of memory pages linked to logical addresses, the virtual map being stored in a linear address space, and updating addresses stored in a translation lookaside buffer (TLB) for recently accessed pages in response to memory accesses made to the MMU table, wherein the MMU table comprises at least first and second level table entries having fixed locations in the linear address space, the first level table entries include data which maps to the physical addresses of the second level table entries, the second level table entries provide mapping to physical addresses for data storage and the step of mapping the first level entries to second level table entries uses a mapping device and the step or mapping the second level entries to physical addresses for data storage uses the same mapping device.

31. A method according to claim 30 including the step of storing the first level table entries in a continuous portion of memory.

32. A method according to claim 30 executable in a microprocessor system.

33. A method according to claim 30 in which the memory is accessible to a plurality of executing threads and providing access to a global area accessible by all the executing threads and providing access to each of a plurality of local areas accessible only to a respective executing thread.

34. A method to claim 33 comprising the step of providing access to addresses in each local area using data specific to that local area's respective thread.

35. A method according to claim 33 in which the step of providing access to the global area is performed using data available to all threads.
